(19) United States
(12) Patent Application Publication
(10) Pub. No.: US 2014/0139140 A1
(43) Pub. Date: May 22, 2014

(54) Encapsulation of DALI Commands in Wireless Networks

(71) Applicant: Verified Energy, LLC, Rochester, NY (US)

(72) Inventors: Thomas I. Yeh, Rochester, NY (US); David W. Sheehan, Glenville, NY (US)

(73) Assignee: VERIFIED ENERGY, LLC, Rochester, NY (US)

(21) Appl. No.: 14/165,031

(22) Filed: Jan. 27, 2014

Related U.S. Application Data
(63) Continuation of application No. PCT/US2012/048340, filed on Jul. 26, 2012.
(60) Provisional application No. 61/512,189, filed on Jul. 27, 2011.

(51) Int. Cl. H05B 37/02

(52) U.S. Cl. CPC H05B 37/02
USPC 315/297

(57) ABSTRACT

An exemplary lighting control system and method to use the same in which the lighting system may incorporate wireless communications between a DALI controller and DALI controlled devices while maintaining adherence to DALI protocol. The system comprises a DALI protocol based controller (master) connected via a first two wire data bus (e.g. a twisted pair wire) to a controller-side wireless module. The controller-side wireless module communicates via a wireless communication protocol (e.g. Wi-Fi, Zigbee) to at least one device-side wireless module. Each device-side wireless module is connected to a DALI stream via a second two wire data bus to at least one DALI ballast (slave) which is connected to at least one lamp bank. Additional devices may be connected to the DALI stream.

### CROSS-REFERENCE TO RELATED PATENT APPLICATIONS

This patent application is a continuation of applicant's patent cooperation treaty application PCT/US2012/048340 (filed in United States on Jul. 26, 2012) which in turn claimed priority based upon U.S. provisional patent application 61/512,189 (filed on Jul. 27, 2011). The entire disclosure of both patent applications is hereby incorporated by reference into this specification.

### STATEMENT REGARDING U.S. FEDERALLY SPONSORED RESEARCH OR DEVELOPMENT

The U.S. Government has a paid-up license in this invention and the right in limited circumstances to require the patent owner to license others on reasonable terms as provide for by the terms of DOE Cooperative Agreement DE-EE0003971 CFDA No. 81.086 awarded by the Department of Energy.

### TECHNICAL FIELD

The current invention relates to lighting control systems and building control systems for homes, offices, commercial spaces, and public areas; more particularly to incorporating wireless networks into the lighting control systems; more particularly to lighting control systems using digitally addressable lighting interface (DALI) command protocol.

### BACKGROUND OF THE INVENTION

Centrally controlled lighting systems for homes, offices, commercial spaces, and public areas are well known in the art. One such control system is known as DALI (Digital Addressable Lighting Interface). DALI is a digital protocol for networking lighting control devices. DALI's two-wire data bus connects a plurality of up to 64 DALI lighting control devices (referred to as controlled devices hereafter), such as ballasts, occupancy sensors, photo sensors and wall switches, to one DALI controller via physical and electrical connections termed as “ports”. The DALI controller may be a central computer or other intelligent control unit.

Standards for DALI protocol such as National Electronics Manufacturers Association LSD 53-2010 in the United States and DALI Manual by ZVEI-Division Luminaires of Frankfurt Germany are well known in the Art.

In FIG. 1 a simplified typical wired implementation of a DALI control system 100 is depicted. As those skilled in the art are aware, a DALI stream is defined as at least one DALI controller 110 and at least one controlled device 210 interconnected by a bus 120 made of two wires. To improve the noise immunity of the bus 120 the two wires are frequently deployed as a twisted pair.

DALI controllers and controlled devices may be connected as a star or (more commonly) may be daisy chained. The DALI specification provides for up to 64 controlled devices (ballasts, switches, sensors, etc.) to be connected to a common twisted pair bus. The bus 120 also requires a DC voltage, which may be physically provided as a standalone power supply 120 or the power supply function may be integrated into the physical package of a DALI controller or controlled device. Only one power supply is allowed.

Consequently, a DALI stream is one or more DALI controllers connected to a common twisted pair bus with up to 64 DALI controlled devices. The stream is energized by a DC voltage provided by a standalone power supply or by a DALI device connected to the stream.

One DALI controller 110 with a DALI port is connected to one DALI stream consisting of at least a single DALI controlled device 210 via a wired data bus 120. A DALI controlled device 210 is typically a DALI controllable ballast in a DALI controllable network but as those skilled in the art are aware, the DALI specification (NEMA LSD 53-2010) includes additional controlled device types, such as switch device, slide dimmer, motion (occupancy) sensor, scheduler, gateways, to name a few. The DALI specification also allows for multiple DALI controllers initiating DALI commands (both commands requiring no response and commands (also known as query commands or queries) requiring a response from the controlled devices) to the controlled devices connected on the same stream as the controllers. The terms “query” and “query command” as used herein are interchangeable and refer to a command requiring a response from the controlled devices.

In a wired implementation, a single stream and a DALI port has a one to one correspondence. One DALI port is also physically a single DALI stream formed by the two communications wires emanating and connecting all the DALI controlled devices on the stream. A ballast may be wired to a lamp 220 or a bank of lamps.

DALI protocol by specification is designed to transmit data at 1,200 cycles per second (Hertz (Hz)), plus or minus 10 percent. The time duration of each cycle is nominally equal to 833.33 microseconds.

A DALI forward frame is defined as a command transmitted from the DALI controller and contains an address byte and one or two data bytes.

A 2-bytes DALI forward frame, consisting of one address byte and a data byte, has 19-bits of data. A 3-bytes DALI forward frame, consisting of one address byte and two data bytes, has 27-bits of data.

A DALI back frame, defined as a reply responding to the immediate forward frame, consists of 11-bits of data.

DALI protocol employs Manchester encoding for serial data transmission. Manchester encoding requires two sampling intervals to decode a single data bit. DALI protocol refers to each sampling interval as “TE”. The duration of each TE is one half of 833.33 microseconds.

In a DALI control system, the DALI controller 110 is frequently sending commands and queries to the DALI controlled devices 210 to ensure optimal operation of the DALI controlled devices 210. The DALI specification maintains a 22 TE maximum limit for each DALI controlled device 210 to respond to the DALI controller 110 for DALI commands requiring a response. This maximum limit of 9.16667 milliseconds is encoded into the protocol and is required of each DALI controlled device 210 when responding to the DALI controller 110.

There are many reasons why implementation using a wireless network would be desired, including simplifying building renovation and reduced installation expense by elimination of problematic communication wiring (i.e. long run communication wiring). A significant shortcoming of wireless network based implementations (e.g. implementing Zigbee protocol) is that the communications between devices cannot be guaranteed to occur within the DALI specification's maximum response time. The timing requirements of the DALI protocol are designed for a communication media where a DALI controller and the connected DALI stream is hardwired in a fashion that the delays or latency introduced by the media are near zero. This makes DALI incompatible with wireless communication media, where latency is non-deterministic and varies greatly depending on real-time network conditions, and can exceed the timing requirements of the DALI protocol. This is problematic for DALI configuration and special commands where the commands must be repeated within a specified timeframe as received by the DALI controlled device on the connected stream or it will be ignored. For DALI query commands, the protocol specifies a very short timing requirement for the responding DALI back frame (e.g. “data”) such that it is unreliable for most wireless networking schemes, especially a wireless network with low to moderate data rate such as Zigbee, to maintain compatibility with the DALI protocol.

Without implementing a caching approach it will be costly, complicated and difficult to guarantee compliance with the DALI specification's maximum 22 TE limit for the DALI controlled device to response to the DALI controller. DALI commands that do not require a response from the DALI controlled device (e.g. unidirectional commands) do not require any accommodations on a controller-side wireless module functioning as an encapsulation gateway. In order to transparently encapsulate the DALI protocol, the encapsulation gateway attached to the DALI controller (controller-side encapsulation gateway) must cache data for all commands that the DALI controller could dispatch.

Automatic DALI Query

Inserting intermediate wireless or non-instantaneous medium between two digitally addressable lighting interface (DALI) nodes automatically precludes all abilities to guarantee support of the DALI specified timings. Taking for example a DALI query command, the DALI controlled device must start the transmission of the back frame within 9.16667 milliseconds (ms) of the completion of the forward frame. If the DALI controlled device begins transmission at 9.16666 ms, it is technically within DALI specification. In this case, the intermediate DALI medium would have 0.00001 ms to fully convey the first bit of the message to the DALI controller. A hardwired bus can readily accomplish this transmission. If there is an intermediate medium in the form of a wireless network or a signal translation means in addition to the hardwired bus, there is currently no way to guarantee this no matter how fast the intermediate communication medium is.

Due to the nature of the DALI protocol, asynchronous communication is not possible. The DALI controller has no way to send another forward frame while it waits for a back frame from a previous query command. Additionally, the only way the back frame is associated with a forward frame is that the back frame immediately follows the forward frame on the DALI stream (within 22 TE). As a result, no other DALI commands can be interjected between a forward frame and its corresponding back frame.

Given these limitations of DALI, the only other approach to allow for use of a wireless network would be to use a non-DALI protocol on the controller-side wireless module. This approach is non-interoperable, complex, requires custom implementations on the wireless module connected to the controlled devices, and thereby has consequences far exceeding those provided by having the intermediate communication medium.

DALI Command Sequencing

Some intermediate communication mediums such as those based on wireless mesh networks do not generally guarantee that messages are received in the same order that they are sent. Other examples of such mediums are Internet Protocol communication using User Datagram Protocol (UDP).

In typical uses of control protocols, including DALI, message ordering is critical. If an OFF and ON command for the lights is reversed, the state of the lights will be drastically different than the desired case. Likewise, during any configuration operation, multiple commands will typically be required. If these are not processed in the correct order, the configuration may either not take place or take place incorrectly.

Although an upper-level protocol could be used for encapsulation that ensures sequencing, these generally require too much overhead in the way of bandwidth, communication latency, underlying physical medium, and processing and memory overhead on the encoding/decoding node and are therefore not practical to implement.

The present invention takes a simple approach at the cost of an additional 16 to 32-bits per message that allows guarantee of sequence without the need for excess overhead or processing. This allows greater choice of the intermediate communication medium as well as minimizes the system requirements of the encoding/decoding node while at the same time ensuring proper operation of the application layer lighting control.

The present invention allows for true DALI operation in a wireless system which takes advantage of the full range of features of the DALI protocol including device interoperability between device manufacturers and the cost savings and simplicity of a wireless system.

### SUMMARY OF THE INVENTION

### Automatic DALI Query

In FIG. 2 a preferred embodiment of an exemplary lighting control system is depicted. A DALI controller 310 (master) is connected via a first two wire data bus 320 (e.g. a twisted pair wire) to a controller-side wireless module 330. The controller-side wireless module 330 communicates via a wireless communication protocol (e.g. Wi-Fi, Zigbee) to at least one device-side wireless module 350. Each device-side wireless module 350 is connected to a DALI stream via a second two wire data bus 360 to at least one DALI ballast 370 (slave) which is connected to at least one lamp bank 380. Additional devices may be connected to the DALI stream. To simplify the description of the preferred embodiment, consider the example where a single device-side wireless module communicates with the controller-side wireless module 330 and where the single device-side wireless module 350 is connected to a single DALI ballast 370 connected to a single lamp bank 380. Though there are several devices that may connect to the device-side wireless module 350 via the second two wire data bus 360, the device-side wireless module 350 will always be connected to at least one ballast 370; and for ease of narrative, the device-side wireless module 350 will hereafter be referred to as the ballast-side wireless module 350. Also to simplify the description, the term ballast will refer to any peripheral device that may be used in a DALI stream. As those skilled in the art are well aware these peripheral devices may include, but are not limited to, ballasts, sensors, dimmer switches, timers, and the like. The term “controlled device” will hereafter refer to a peripheral device such as a ballast. The controller-side wireless module 330 and the ballast-side wireless module 350 comprise an encapsulation gateway 345.

Common DALI commands and queries (e.g. commands requiring a back frame) are issued and cached in a command list automatically by the ballast-side wireless module upon system start up. This allows the command list to be populated before the DALI controller begins issuing commands and queries and allows the controller-side wireless module to only have to issue queries required for its operation without consideration for other queries potentially not being available should they be needed later. The controller-side wireless module comprises a data store which caches commands and back frames. The encapsulation gateway comprises a cache system which is comprised of the command list and the data store.

When the ballast-side wireless module 350 sees a command that is followed by a back frame that is not in its command list, it will be added to the command list automatically (such as a reserved, non-standard command).

Discovered query commands will continue to be cached in the command list so long as at least one ballast 370 (controlled device 370) keeps responding to the queries.

When a ballast stops responding to queries to update the command list cache, metadata associated with the data store cache entry for that particular ballast on the controller-side wireless module 330 will be updated. This metadata will prevent the controller-side wireless module 330 from responding to that query for that particular ballast to the DALI controller 310 and will allow the DALI controller 310 to see the identical behavior to the command as occurs on the ballast-side wireless module 350.

When a dynamically detected command becomes non-responsive by all ballasts on the DALI stream for an extended period of time, the controller-side wireless module 330 will make the command eligible for cache removal at a later point in time. This denotation by the controller-side wireless module 330 is used in case a new command is dynamically detected in the future and the cache is entirely full. In this scenario, the controller-side wireless module 330 can remove a dynamically detected command not being used by the system to allow room for a command that is being used. If a command has been marked as non-responsive but becomes responsive again, the denotation will be removed.

Alternatively, for the same reasons, the controller-side wireless module 330 may elect to remove a command from the data store cache when a long enough time period elapses without the DALI controller 310 issuing the command to the module.

If the DALI controller 310 issues a query for a command that is not contained in the data store cache, the controller-side wireless module 330 will not respond. As a result, there is a startup time at which the controller-side wireless module 330 will not respond to commands while the data store cache is being populated. It is expected that it will only take several seconds to initially construct the data store cache. In another embodiment of the present invention, the data store may alternatively be preloaded with an arbitrary cache of commands and queries to reduce the start-up lag time. As those skilled in the art are well aware, the preloading of the data store cache will not significantly effect the operation of the present invention.

All commands issued by the DALI controller 310 that are not part of the data store are forwarded to the ballast-side wireless module 350 and executed normally in sequence. Though queries may be handled in this manner, this will apply more frequently to any command that does not require a response from the controlled device 370.

DALI Command Sequencing

The controller-side wireless module 330 transmitting a lighting command comprises a DALI encapsulator which encapsulates the data in a packet structured according to the underlying communication medium selected. To support proper sequencing, the DALI encapsulator includes in the packet metadata comprising a timestamp and a sequence identifier that is incremented with each packet transmitted to a particular ballast-side wireless module 350. Each packet is transmitted wirelessly to the ballast-side wireless module 350 in a message.

The ballast-side wireless module 350 places each command into a priority queue. Due to the sequence identifier in each message, the ballast-side wireless module 350 can identify if it is missing a preceding message within the sequence before passing the message to the actual controlled device 370. Likewise, with the timestamp, the ballast-side wireless module 350 can identify how long to wait before giving up on receiving the preceding message and can then send the subsequent message after the timeout occurs.

The sequence identifier is unique within the scope of each ballast-side wireless module 350 and tracked separately for each ballast-side wireless module 350. This is required as a result of the fact that typically messages being forwarded to the ballast-side wireless module 350 are destined for a single ballast 370 and therefore the message is only sent to a single ballast-side wireless module 350. Because of this, the sequence identifier must increment without gap within the context of the ballast-side wireless module 350 otherwise the module 350 would perceive that a message has been lost while in fact it was simply a message that wasn't destined to that particular ballast-side wireless module 350.

In some circumstances, it is not desirable to send the subsequent message if the preceding message is never received, such as when configuring a parameter on a controlled device. In addition, in an effort to save overhead, the sequencing system bundles certain underlying lighting functions into a single packet over the communication medium even in cases where the lighting protocol (such as DALI) utilizes multiple commands to complete the operation. An example of this is the DALI set DTR command with subsequent commands that act on the value stored within the DTR. This behavior guarantees that the subsequent commands are only run if the DTR is properly set as well as manages bandwidth on the intermediate medium by only sending one packet instead of several.

As a method of increasing the reliability and deterministic behavior of the system, although the DTR command is one example of a DALI command that is grouped with a configuration command and sent as a single entity, the controller-side wireless module 330 will typically broadcast the DTR value to all modules 350 servicing the DALI stream to ensure that the DTR is set properly for all possible implementations of the DALI controller 310. As an example, the DALI controller 310 may send a set DTR message and then issue a configuration query using that single DTR value on multiple ballasts 370. This approach allows the controller-side wireless module 330 to be more efficient and ensure more robust behavior in the case of errors in the intermediate communication medium.

The sequence identifier contained within each packet is guaranteed to be sequential based on the system characteristic that a single ballast-side wireless module 350 manages all communication with a single controlled device 370 (such as a ballast). In other words, A ballast will only receive commands from a single source, namely the ballast-side wireless module it is connected to, albeit the ballast-side wireless module could serve as an aggregator and therefore receive logical commands from several upstream lighting control systems or sources.

### BRIEF DESCRIPTION OF FIGURES

Embodiments of the present invention will be described by reference to the following drawings, in which like numerals refer to like elements, and in which:

FIG. 1 depicts a hard wired lighting system using a DALI interface;

FIG. 2 depicts an exemplary wireless lighting system using a DALI interface;

FIG. 3 depicts a schematic view of a method for data caching on a ballast-side wireless module;

FIG. 4 depicts a schematic view of a method for data caching on a controller-side wireless module;

FIG. 5 depicts a method for DALI sequencing within a encapsulation gateway;

FIG. 6 depicts in additional detail an exemplary wireless lighting system using a DALI interface;

FIG. 7 depicts a flow chart for a method to process data on a ballast-side wireless module;

FIG. 8 depicts a flow chart for a method to process a DALI command on a controller-side wireless module;

FIG. 9 depicts a flow chart for a method to process a wireless command on a controller-side wireless module;

FIG. 10 depicts a schematic representation for a method to process data caching on a ballast-side wireless module; and

FIG. 11 depicts a schematic representation for a method to process data caching on a controller-side wireless module.

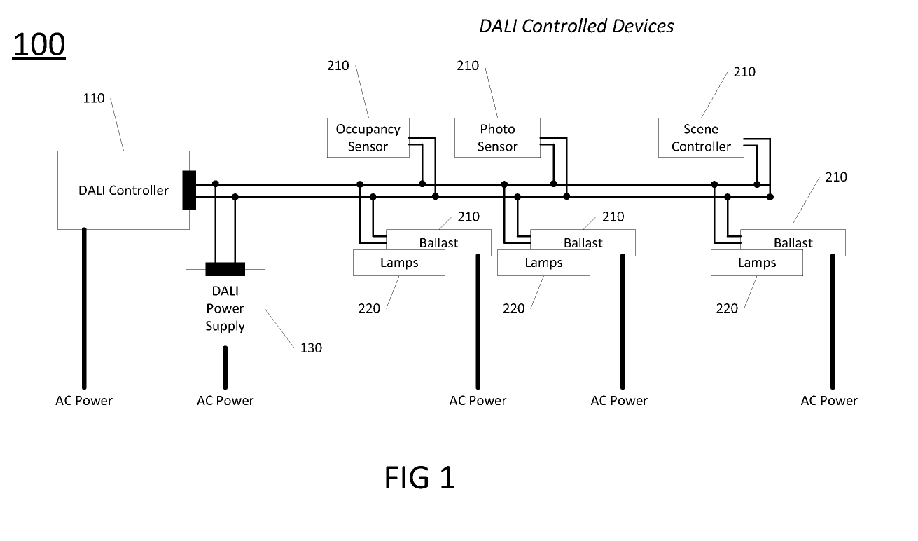

### DETAILED DESCRIPTION OF THE INVENTION

The present invention relates to the encapsulation of DALI commands in wireless networks.

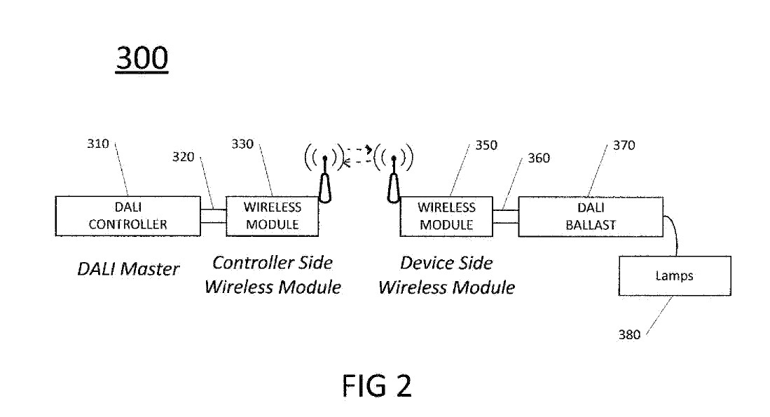

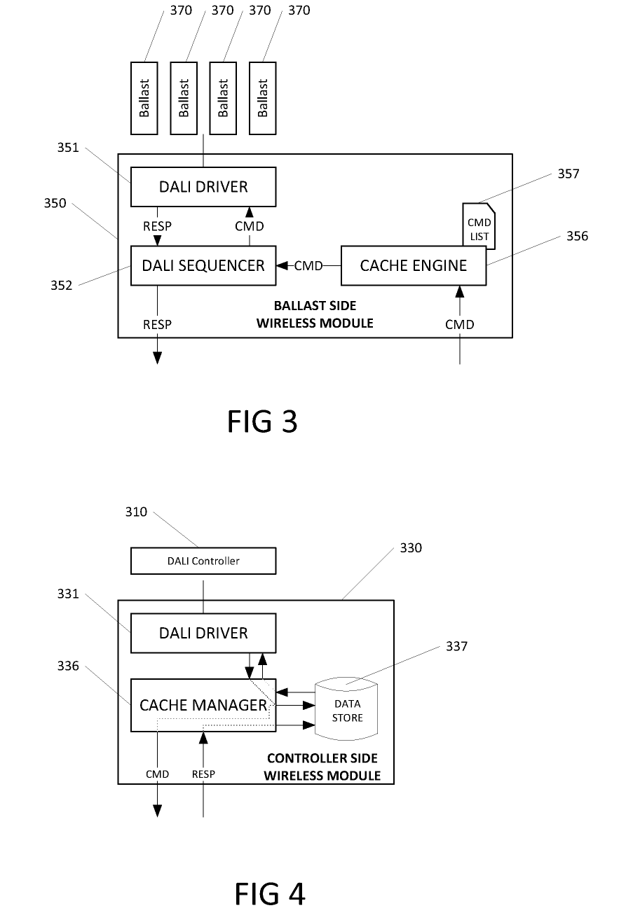

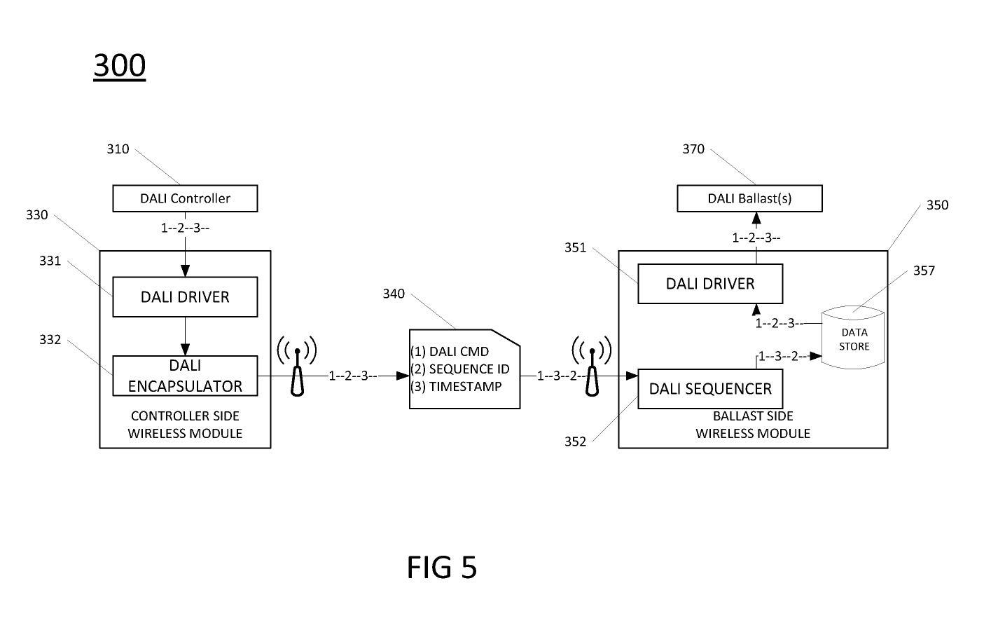

In FIGS. 2 through 6 a preferred embodiment of an exemplary lighting control system is depicted. A DALI controller 310 (master) is connected via a first two wire data bus 320 (e.g. a twisted pair wire) to a controller-side wireless module 330. The controller-side wireless module 330 communicates via any common wireless communication protocol (e.g. Wi-Fi, Zigbee) to at least one ballast-side wireless module 350. Each ballast-side wireless module 350 is connected via a second two wire data bus 360 to at least one DALI ballast 370 (slave) which is connected to at least one lamp bank 380. To simplify the description of the preferred embodiment, consider the example where a single ballast-side wireless module 350 communicates using Zigbee communication with the controller-side wireless module 330 and where the single ballast-side wireless module 350 is connected to a single DALI ballast 370 connected to a single lamp bank 380. Also to simplify the description, the term “ballast” will refer to any “peripheral device” that may be used in a DALI stream and the two terms may be used interchangeably along with the term “controlled device”. As those skilled in the art are well aware these peripheral devices may include, but are not limited to, ballasts, sensors, dimmer switches, timers, and the like. A DC power supply, not shown, may be integrated with the DALI Controller 310 or may be provided separately to the DALI controller 310. A separate DC power supply, also not shown, may be integrated with the ballast-side wireless module 350 or may be provided separately to it. The controller-side wireless module 330 and the ballast-side wireless module 350 each comprise several software modules which provide for the seamless control of the lamp bank 380 by the DALI controller 310 even though the DALI controller 310 is not hard wired directly to the DALI ballast 370. As depicted in FIG. 3, on the ballast-side wireless module 350 there is a ballast DALI driver 351, a DALI sequencer 352, a cache engine 356, and a command list 357. As depicted in FIGS. 4 and 5, on the controller-side wireless module 330 there is a controller DALI driver 331, a DALI encapsulator 332, a cache manager 336, and a data store 337.

Referring to FIG. 3 and the preferred embodiment of the present invention, a schematic of the ballast-side wireless module 350 is depicted. DALI commands are issued and cached to the command list 357 automatically by the ballast-side wireless module 350. The command list 357 is initially populated with a default list of commands. This list of commands (cache) is prepopulated with queries that are required for basic system operation. This allows the cache to be populated before the DALI controller 310 (not depicted in FIG. 3) begins issuing commands and allows the ballast-side wireless module 350 to only have to issue queries required for ballast-side wireless module 350 operation without consideration for other required queries potentially not being available until later.

When the ballast-side wireless module 350 sees a command that is followed by a back frame that is not in its list 357 of cached commands, the command will be added to the command list 357 automatically (such as a reserved, non-standard command).

Discovered query commands will continue to be cached in the command list 357 so long as the DALI ballast 370 keeps responding to the queries.

When the ballast 370 stops responding to queries, the cache values will not update on the controller-side wireless module data store 337 (not depicted in FIG. 3).

The command list 357 is initially populated with a default list of commands. This list of commands is prepopulated with queries that are required for basic system operation. The cache engine 356 transmits these commands to the DALI sequencer 352 which transmits these commands to the ballast DALI driver 351. The ballast DALI driver 351 sends commands and queries to the ballast 370 and receives responses back from the ballast 370. The ballast 370 follows the command, and if the command is a query then the ballast 370 will send a response (back frame). The responses are sent to the DALI sequencer 352 which wirelessly transmits the response to the controller-side wireless module 330 (not depicted in FIG. 3).

The cache engine 356 also receives wirelessly transmitted commands from the controller-side wireless module 330. These commands are received in individual packets and each packet comprises a DALI command, a sequence identification code (ID), and a timestamp. The sequence ID is incremented with each packet transmitted and identifies the order in which the command was transmitted by the DALI controller 310 so that the ballast-side wireless module 350 can correctly sequence the order that commands are transmitted to the at least one particular ballast 370. The timestamp identifies when the DALI controller 310 initiated the command. The cache engine 356 compares the commands that it receives with those in the command list 357. The cache engine 356 forwards commands to the DALI sequencer 352 which reviews the sequence ID of the command and reorders the commands when they are determined to be out of proper sequence. Once the commands are in correct sequential order, the DALI sequencer 352 forwards the commands to the ballast DALI driver 351 which forwards the commands to the appropriate ballast 370. Any response (back frame) is transmitted to the ballast DALI driver 351. The responses are sent to the DALI sequencer 352 which ensures that the correct sequence ID and timestamp are associated with the response and wirelessly transmits the response to the controller-side wireless module 330.

Referring now to FIG. 4, a schematic of the controller-side wireless module 330 is presented. The controller-side wireless module 330 comprises the data store 337, the cache manager 336, and the DALI driver 331. The data store 337 contains commands and queries from the DALI controller 310 and the responses (back frames) to DALI commands from the DALI ballasts 370 (not depicted in FIG. 4) on the remotely connected DALI stream via the ballast-side wireless module 350 (not depicted in FIG. 4). The data store 337 may optionally be pre-populated with common commands and responses. The DALI controller 310 transmits DALI commands to the controller-side wireless module 330 via the first two wire data bus 320 (not depicted in FIG. 4). When the controller-side wireless module 330 receives a command from the DALI controller 310, it is received by the controller DALI driver 331. The controller-side wireless module 330 receives DALI commands 331 from the DALI controller 310 in a specific order (e.g., 1, 2, 3,).

The controller DALI driver 331 transfers the command to the cache manager 336 which will attempt to service the command from the data store 337. If the cache manager 336 finds an appropriate response to the command available in the data store 337, it provides that response to the controller DALI driver 331 which in turn provides the response back to the DALI controller 310. If the cache manager 336 does not find an appropriate response to the command in the data store 337, the cache manager 336 will select that command to be wirelessly transmitted to the ballast-side wireless module 350. The cache manager 336 will also select non-query commands to be transmitted to the ballast-side wireless module 350.

The cache manager 336 will receive responses for cached data store commands from the ballast-side wireless module 350. These responses are used to update the appropriate data in the data store 337. The values that are removed from the data store 337 may be retained in a historical data store (not depicted). As the cache manager 336 receives commands from the DALI controller 310, it continues to provide the most recent appropriate value from the data store 337 to the controller DALI driver 331.

The controller-side wireless module 330 maintains a local data store 337 containing the responses to DALI commands from the DALI peripherals 370 on the remotely connected DALI stream, and will respond to the DALI controller 310 with the data from the local data store 337 satisfying the timing requirements of the DALI protocol. This process is continuous, in parallel to servicing requests from the DALI controller 310; the ballast-side wireless module 350 will automatically issue DALI commands to the DALI stream and send the responses back to the controller-side wireless module 330 to update the local data store 337. DALI commands that do not require a back frame (“response”) are sent to the ballast-side wireless module 350 immediately, bypassing the local data store 337. This continuous issuing of DALI commands to the DALI stream and updating the data store 337 is a critical component of the present invention and enables the use of wireless communications with the DALI protocol. This is how the present invention allows adhering to the timing protocols of the DALI protocol.

When the controller-side wireless module 330 receives a command from the DALI controller 310, it attempts to service it from the local data store 337 first. If it can't, or if the command is not a query, the command is sent over the wireless link to the DALI peripheral 370 targeted in the request. If the command is a query command, the controller-side wireless module 330 will begin to keep track of it in the data store 337 for future queries.

In the case that too many non-standard DALI queries have been identified by the system in cases that the controller-side wireless module 330 and ballast-side wireless modules 350 are resource constrained, the controller-side wireless module 330 will look at the relative frequency of the command and if the command is issued to one or many of the ballasts 370 on the stream. These additional parameters, including a frequency counter, can be used to potentially replace a command being cached to the data store 337 that is infrequent and of low implied priority from the perspective of the DALI controller 310 with those that are the most important. As those skilled in the art are aware, other criteria could be used in place of or in conjunction with these criteria to determine which cached commands should be replaced and the spirit of the invention is not avoided by choosing other criteria.

In parallel to servicing commands from the DALI controller 310, the controller-side wireless module 330 will periodically receive responses for cached commands which will result in updates to the local data store 337 to prepare for the next time the DALI controller 310 issues the command locally.

Referring to FIG. 5 and the preferred embodiment depicted, the controller-side wireless module 330 additionally comprises the DALI encapsulator 332. The DALI encapsulator 332 encapsulates DALI commands received from the DALI controller 310 for wireless communication using wireless communication protocol, (e.g., Zigbee). The DALI encapsulator 332 receives commands to be transmitted to the ballast-side wireless module 350 from the DALI cache manager 336. To support proper sequencing, the DALI encapsulator 332 creates a command message packet 340 by adding metadata to each command. This metadata comprises the timestamp and sequence ID and the timestamp. This metadata is added to the command to allow the wireless modules to identify the sequence in which the command was issued by the DALI controller 310 and when the DALI controller 310 issued the command. The DALI command is encapsulated in a message packet 340 structured according to the networking protocol such as Zigbee.

As the message packets 340 are transmitted to the ballast-side wireless module 350, they can get out of sequence due to the way wireless systems handle data transmission, and these messages may arrive out of order (such as being sent 1, 2, 3 but arriving as 1, 3, 2,) on the receiving end. On the receiving end the packets 340 are re-sequenced such that they are transmitted to the connected DALI stream in their original order (e.g. back from 1, 3, 2 to 1, 2, 3). This is accomplished through the use of a sequence number and timestamp that are included as metadata with the DALI command.

Within the ballast-side wireless module 350, another physical or software wireless module, the DALI sequencer 352, extracts the DALI commands from the Zigbee communication. As described above, the commands are received by the cache engine 356 (not depicted in FIG. 5) and compared to the commands in the command list 357.

The DALI sequencer 352 places message packets 340 into a queue and sorts them in sequence to ensure that commands are followed in their proper issued order. If commands are merely followed in the order in which they are sent rather than the order in which they are issued, the actions performed by the ballasts 370 when they receive the commands may be significantly different than intended. After properly sequencing the commands, the DALI sequencer 352 sends the commands to ballast DALI driver 351 which in turn is connected to the DALI stream via the second wired bus 360 and transmits the commands to the DALI stream and the ballasts 370 contained therein. The ballast-side wireless module 350 will repeat the command as necessary according to the DALI protocol. The ballast DALI driver 351 will receive responses back, as appropriate, and forward them on to the DALI sequencer 352 which encapsulates the responding DALI response (back frame (e.g. “data”)) from the responding ballast 370 and returns the response to the controller-side wireless module 330 which provides the DALI controller 310 with the response. The ballast-side wireless module 350 will analyze the DALI commands and will automatically and continuously issue the DALI commands to the appropriate DALI peripherals 370 on the DALI stream and send the responses back to the controller-side wireless module 330.

The ballast-side wireless module 350 places each command into a priority queue. Due to the sequence identifier in each message packet 340, it can identify if it is missing a preceding message within the sequence before passing the message 340 to the DALI peripheral 370. Likewise, with the timestamp, the module 350 can identify how long to wait before giving up on receiving the preceding message and can then send the subsequent message after the timeout occurs.

In some circumstances, it is not desirable to send the subsequent message if the preceding message is never received, such as when configuring a parameter on a DALI peripheral. In addition, to save overhead, the sequencing system bundles certain underlying DALI functions into a single packet over the communication medium even in cases where the DALI protocol utilizes multiple commands to complete the operation. An example of this is the DALI set DTR command with subsequent commands that act on the value stored within the DTR. This behavior guarantees that the subsequent commands are only run if the DTR is properly set as well as manages wireless bandwidth by only sending one packet instead of several.

The sequence identifier contained within each packet is guaranteed to be sequential based on that the controller-side wireless 330 module aggregates DALI commands from all of the DALI controllers on a DALI stream.

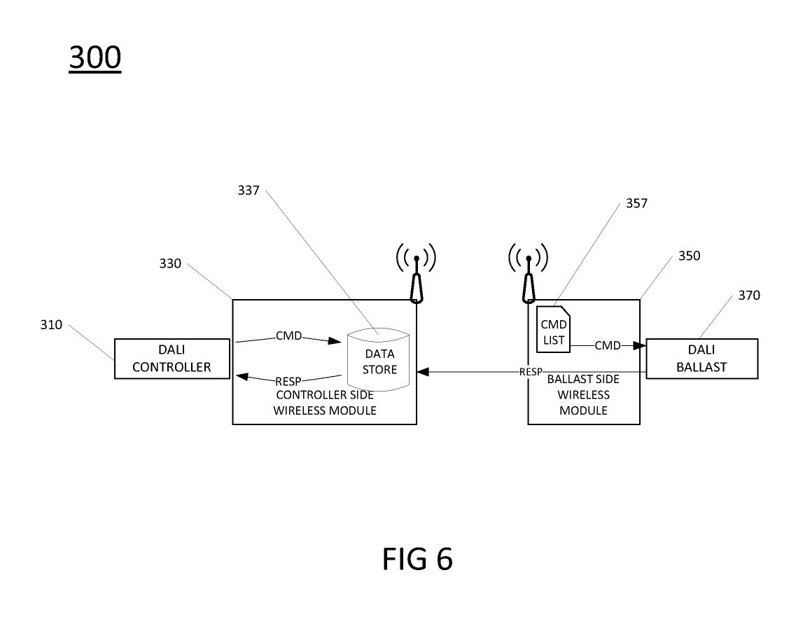

Referring now to FIG. 6, whenever a wireless message is received by the controller-side wireless module 330 from a ballast-side wireless module 350, it is used to update the data store 337 cache, or add a new command to the data store 337 command cache if it was found to be a query instead of a unidirectional command.

When values on the controller-side wireless module 330 become too old, the controller-side wireless module 330 will no longer place back frames on the controller-side stream (responding to the DALI controller's 310 query); that is the same behavior as if the DALI peripheral 370 was wired directly to the DALI controller 310.

If the DALI controller 310 issues a query for a command that is not contained in the data store 337 cache, the controller-side wireless module 330 will not respond to the query. As a result, there is a startup time at which the controller-side wireless module 330 will not respond to commands while the data store 337 cache is being populated. It is expected that it will only take several seconds to initially construct the cache. It should be obvious to those skilled in the art that the data store 337 cache could initially be populated with default values to speed the system startup; and using a prepopulated cache will not avoid the present invention.

All commands issued by the DALI controller 310 that are not part of the data store 337 cache are forwarded to the ballast-side wireless module 350 and executed normally in sequence. This is mostly applicable to commands that do not require a response from the controlled device 370.

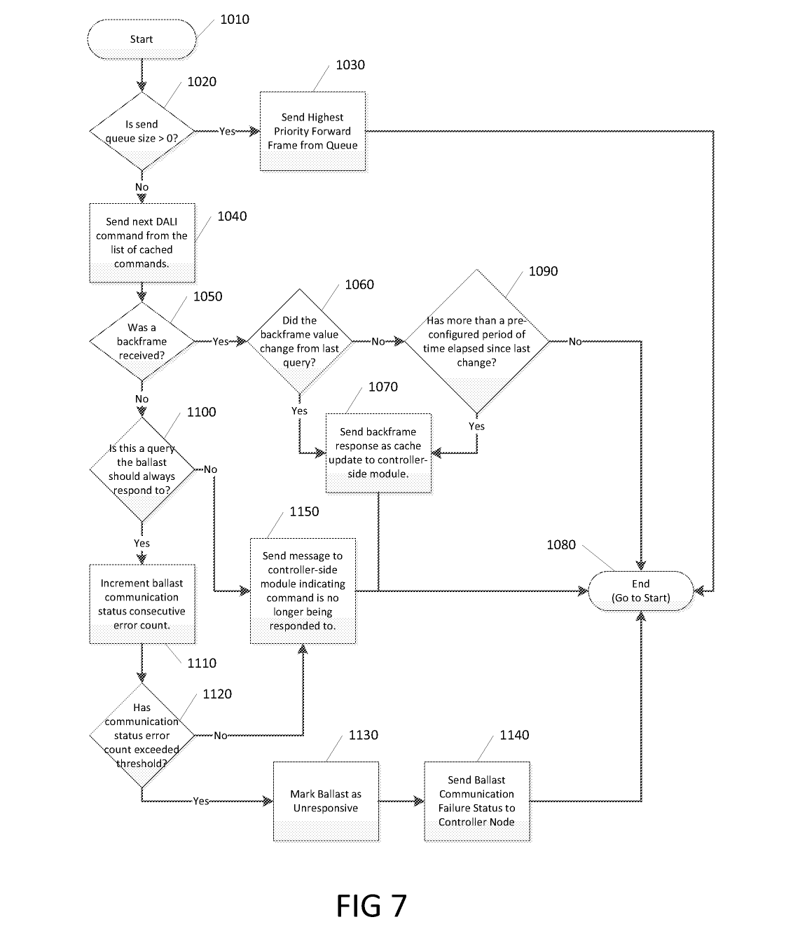

FIGS. 7, 8, and 9 present flow charts of the method used to process DALI and wireless commands on a controller-side wireless module and ballast-side wireless module. Referring to FIG. 7, the control logic for operating a ballast-side wireless module is depicted. The ballast-side wireless module contains a ballast DALI driver. The ballast DALI driver handles the low-level DALI protocol and receives commands from a DALI sequencer. The DALI sequencer is given DALI commands to execute from a local command cache engine.

The cache engine will issue any DALI commands it receives from controller-side wireless modules intermixed with DALI commands from a local command list that are used to update a data store cache on the controller-side wireless module.

Responses from DALI controlled devices are sent directly to the controller-side wireless module.

In Step 1010, the system is initiated.

In Step 1020, the existence of a command priority queue is established. When there may be a backlog of transmittable back frames, a priority queue is developed. The priority queue is established to allow for commands that will require frequent and/or critical responses from ballasts to be sent to the appropriate ballasts with a higher priority than those that will not require frequent updating. For example, a query as to whether a motion sensor detects occupants in a room would result in more dynamic results than a query as to which ballast is at the second position in the DALI stream. If there is a priority queue, proceed to Step 1030 and send the highest priority forward frame from the priority to queue to the appropriate ballast. If there is not a priority queue, proceed to Step 1040.

In Step 1040, the next command on a command list is transmitted to the appropriate ballast. In Step 1050, the ballast-side wireless module determines whether a back frame was received. If a back frame was received, proceed on to Step 1060, if not, proceed on to Step 1100.

In Step 1060, the back frame value is compared to the previous back frame value kept in the command list. If the new back frame value has changed from the previous value, proceed on to Step 1070. If the back frame value has not changed from the value kept in the command list, then proceed on to Step 1080.

In Step 1070, the ballast-side wireless module transmits the back frame response to the controller-side wireless module to update that cached value in the data store. Upon completing Step 1070, proceed to Step 1080 and return to Step 1010 to repeat the process.

In Step 1090, the length of time between the last two times this query has been sent to the particular ballast is reviewed. If an appropriate threshold time has not passed, then proceed on to Step 1080 and return back to Step 1010. If an appropriate threshold time has passed, then proceed on to Step 1070.

In Step 1100, the query sent in Step 1040 is reviewed to determine whether the ballast should always respond to that query. If the query should always be responded to, then proceed on to Step 1110; if the query does not need to be responded to every time it is received, then proceed to Step 1150. An example of a query that should always be responded to is a request to determine the arc power level of the ballast; and an example of a query that may be ignored would be a lamp error query.

In Step 1110, a ballast communication status consecutive error count counter is incremented by one.

In Step 1120, determine whether the ballast communication status consecutive error count counter has exceeded a threshold for reporting back to the DALI controller that the ballast is not responding. If the threshold has been reached proceed on to Step 1130; if the threshold has not been reached, proceed on to Step 1150.

In Step 1130, the ballast is marked as unresponsive and a ballast communication failure status notice is sent to the controller-side wireless module so that the ballast communication failure may be relayed to the DALI controller.

In Step 1150, a message is sent to the controller-side wireless module indicating that that command is no longer receiving a response. Proceed on to Step 1080 and then back to Step 1010.

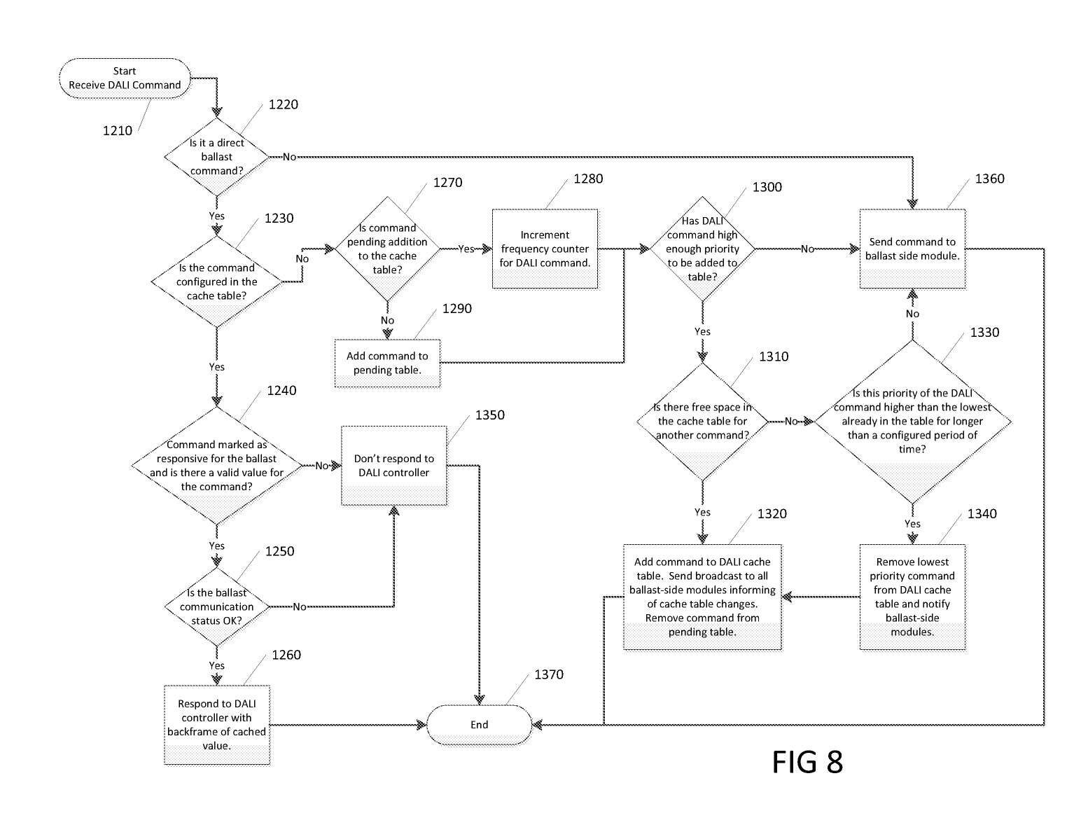

Referring to FIG. 8, the control logic for responding to a DALI command on a controller-side wireless module is depicted. In Step 1210, a DALI command is received from a DALI controller.

In Step 1220, the command is evaluated to determine if it is a direct ballast command or a broadcast command. As those skilled in the state of the art are aware, within DALI protocol a direct ballast command is one directed to a particular ballast port and a broadcast command is directed to at least two ballasts. As those skilled in the art are additionally aware, a 2-byte broadcast command can also be a query when the system consists of just a single controlled device capable of responding (e.g. ballast). When broadcast commands are send to multiple controlled devices capable of responding, through limitations of the DALI protocol, the DALI controller would have no direct way of knowing which back frame responding to the query was from which ballast, since the back frame lacks identification of the responding device. A direct command may be a query or it may be a simple command not requiring a back frame. If the command is a direct ballast command, proceed to Step 1230; if the command is not a direct ballast command, proceed to Step 1360.

In Step 1230, the command is compared to those listed in a cache manager's cache table used to manage the data store. If the command is listed in the data store, then proceed to Step 1240; if the command is not listed in the data store, then proceed to Step 1350.

In Step 1240, the command is marked as being responsive for the ballast it is directed toward, and the data store is evaluated to determine if a valid value is in the data store. If a valid value is in the data store, proceed to Step 1250; if a valid value is not in the data store, proceed to Step 1350.

In Step 1250, the communication status of the ballast the command is directed towards is evaluated. If the communication status is OK, then proceed on to Step 1260; if the communication status is not OK, then proceed on to Step 1350.

In Step 1260, the controller-side wireless module responds to the DALI controller with the back frame cached in the data store. Proceed on to Step 1370.

In Step 1270, the command that does not have a value in the data store is evaluated to determine if the command is pending addition to the data store. If the command is pending addition to the data store, then increment a frequency counter for that DALI command and proceed on to Step 1280. If the command is not pending addition to the data store, then proceed to Step 1290.

In Step 1280, the frequency counter for that DALI command is incremented.

In Step 1290, the command is added to a pending table. Its frequency counter may be given a value.

In Step 1300, command priority is reviewed to determine if the command has high enough priority to be added to the cache table. If the command does have high enough priority to be added to the cache table, proceed to Step 1310, otherwise proceed to Step 1360.

In Step 1310, determine if there is enough space in the cache table for another command. If there is, proceed to Step 1320; else proceed to Step 1330.

In Step 1320, add the command to the data store. A broadcast is sent to ballast-side wireless modules to inform them that the data store has been changed. The command is removed from the pending table. Proceed on to Step 1370.

In Step 1330, the command priority of the commands that have been in the data store for longer than a proscribed period is determined. The command with the lowest priority of those that have been in the data store for the proscribed time period is considered to be the lowest priority cached command. The command from Step 1310 is compared to the lowest priority cached command. If the command from Step 1310's priority is higher than the lowest priority cached command, proceed to Step 1340; otherwise proceed to Step 1360.

In Step 1340, remove the lowest priority cached command from the data store and notify the ballast-side wireless modules that this command has been removed from the data store. Proceed to Step 1320.

In Step 1360, send the command to the ballast-side wireless module. Proceed to Step 1370.

In Step 1370, wait to receive another DALI command from the DALI controller.

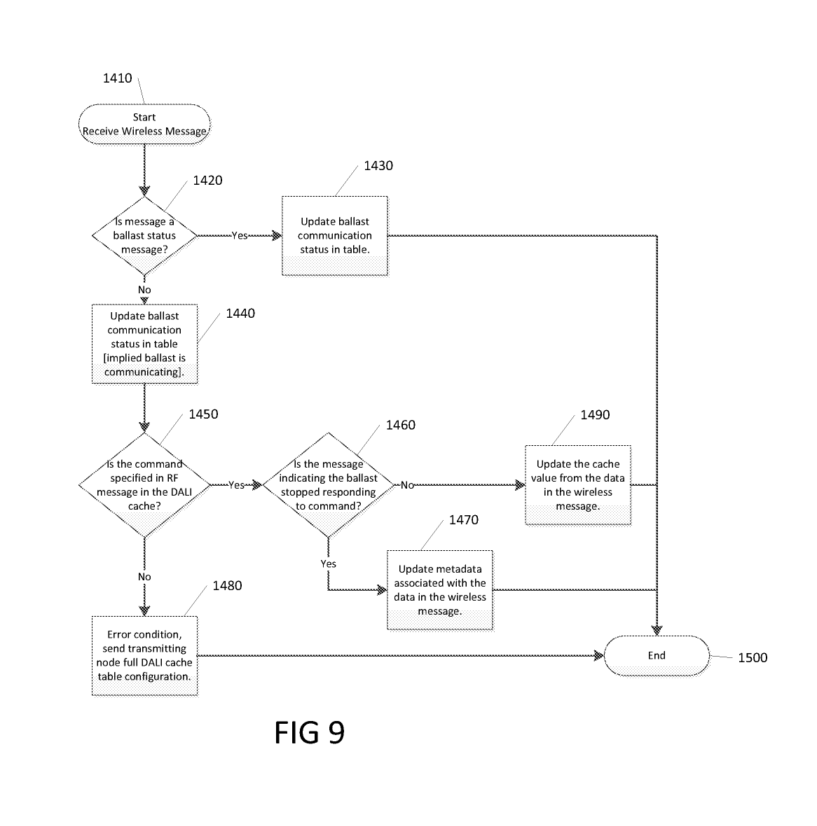

Referring to FIG. 9, the control logic for responding to a back frame from a ballast-side wireless module on a controller-side wireless module is depicted. In Step 1410, a back frame is received from a ballast-side wireless module.

In Step 1420, the message is evaluated to determine if it is a ballast status message. If it is, proceed to Step 1430; if it is not, proceed to Step 1440.

In Step 1430, the ballast communication status is updated in a data table. Proceed to Step 1500.

In Step 1440, the ballast communication status is updated in the data table to indicate that at this moment in time, the controlled device associated with that message is communicating. This can be implied since a back frame was received from the controlled device thereby generating the message received by the controller-side module resulting in processing events leading to Step 1440; proceed on to Step 1450.

In Step 1450, determine if the command specified to be replied to by the back frame is in the data table. If it is, proceed to Step 1460; if it isn't, proceed to Step 1480.

In Step 1460, determine whether the back frame is indicating that the controlled device stopped responding to the command. If it is, proceed to Step 1470; otherwise proceed to Step 1490.

In Step 1470, the DALI encapsulator updates the nnetadata associated with the back frame. Proceed to Step 1500.

In Step 1480, send a message to the ballast-side wireless module that sent the back frame indicating that there is an error condition. The message shall include the entire data table cache for that command. Proceed to Step 1500.

In Step 1490, update the data table with the value from the back frame. Proceed to Step 1500.

In Step 1500, wait to receive another back frame from a ballast-side wireless module.

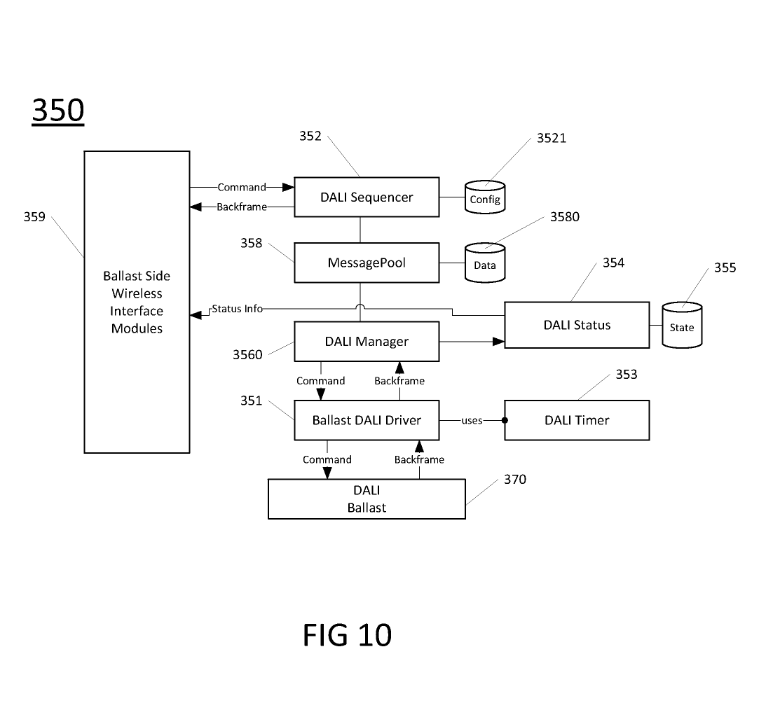

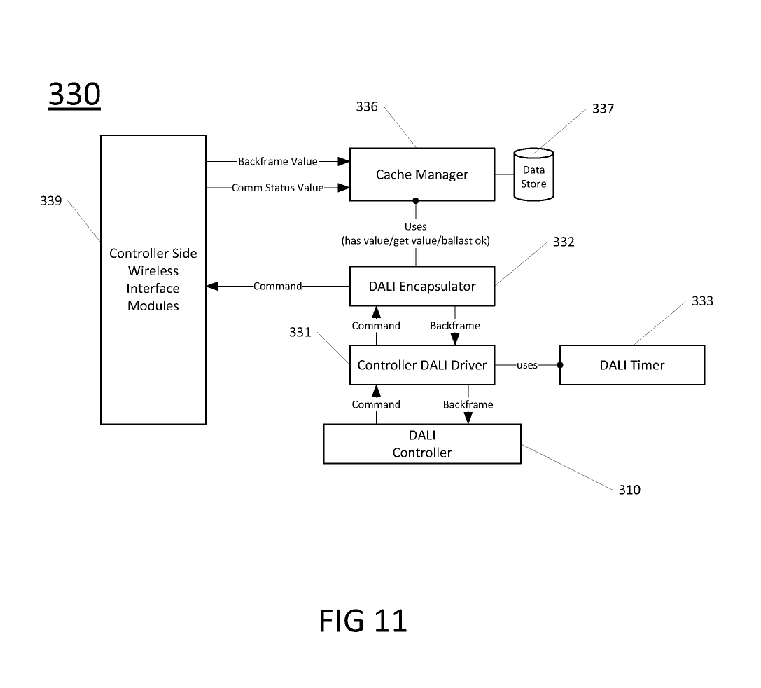

FIGS. 10 and 11 provide schematic diagrams of the ballast-side wireless module 350 and the controller-side wireless module 330 for the preferred embodiment of the present invention. FIG. 10 depicts a schematic diagram of how the modules of the ballast-side wireless module 350 interact with each other in the preferred embodiment of the present invention. The ballast DALI driver 351 interacts with the ballasts 370 on the ballast stream and is wired directly to the ballast stream. The ballast DALI driver 351 uses a DALI timer 353 to ensure responses to the DALI controller 310 (not depicted in FIG. 10) are within the DALI specified timing protocol. The ballast DALI driver communicates with a DALI manager 3560 that is responsible for retrieving the highest priority command to be sent to the ballast 370 from the message pool 358 database 3580 and sending the command to the ballast DALI driver 351 for transmission. The DALI manager 3560 is responsible for associating any received back frames with commands that are sent and directing the data retrieved back through the internal workings of the ballast-side wireless module 350. The DALI manager 3560 is also responsible for facilitating ballast communication status tracking via a DALI status database 354. The values 355 (states) of the DALI status database 354 are transmitted to the controller-side wireless module 330 (not depicted in FIG. 10) via a ballast-side wireless interface module 359. The message pool database 3580 is updated by the DALI sequencer 352. The DALI sequencer 352 receives commands from the ballast-side wireless interface module 359. The commands are received as messages and may be received out of proper sequence. The DALI sequencer 352 places the commands in proper sequence in the message pool database 3580. The DALI sequencer 352 also sends back frames back to the controller-side wireless module 330 via the ballast-side wireless interface module 359. The DALI sequencer 352 is also responsible for scheduling cache update commands to be sent to ballasts 370 based on its cache list configuration 3521 by inserting these commands into the message pool database 3580 with an appropriate priority and sequence. The DALI sequencer 352 also utilizes its configuration 3521 to determine whether a back frame received from the ballast 370 that is part of a cache update command should be dispatched to the controller-side wireless module 330 by virtue of having the value change or a configured time period elapse. The ballast-side wireless interface module 359 communicates with the controller-side wireless module 330 via a controller-side wireless interface module (not depicted in FIG. 10).

FIG. 11 depicts a schematic diagram of how the modules of the controller-side wireless module 330 interact with each other in one preferred embodiment of the present invention. A DALI controller 310 will send commands to a controller DALI driver 331 and receive back frames back from the controller DALI driver 331. The controller DALI driver 331 uses a DALI timer 333 to ensure responses to the DALI controller 310 are within the DALI specified timing protocol. The controller DALI driver 331 communicates with a DALI encapsulator 332 sending commands to the DALI encapsulator 332 and receiving back frames back. The DALI encapsulator 332 communicates with a cache manager 336 providing data from a data store 337 and sends commands to the ballast-side wireless modules 350 (not depicted) via a controller-side wireless interface module 339. The cache manager 336 receives back frames and communication status values from ballast-side wireless modules 350 via the controller-side wireless interface module 339. The cache manager 336 stores the values in the data store 337 and provides these values to the DALI encapsulator 332.

Although several embodiments of the present invention, methods to use said, and its advantages have been described in detail, it should be understood that various changes, substitutions and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged lighting system. Those skilled in the art will also understand that the principles of the present invention may be implemented in any suitably arranged building control system. Examples of such building control systems include but aren't limited to energy minimization systems; heating, ventilation, and air conditioning (HVAC) systems, building security systems, and the like.

We claim:

1. A DALI compatible wireless lighting control system comprising:
a DALI controller;
a first wire bus;
a controller-side wireless module;
at least one ballast-side wireless module;
at least one second wire bus;
at least one DALI compatible controlled device;
and at least one lamp bank.

2. The DALI compatible wireless lighting control system of claim 1 wherein the controller-side wireless module comprises a data store and means to update data in the data store to keep the data current; the controller-side wireless module further comprises a DALI command list which prioritizes commands from the DALI controller; and the controller-side wireless module directly replying to DALI queries with data contained in the data store to satisfy the back frame timing requirements of DALI protocol.

3. The DALI compatible wireless lighting control system of claim 1 wherein the controller-side wireless module comprises a first DALI command list; each ballast-side wireless module comprises an additional DALI command list and a data store; said first DALI command list is synchronized with said additional DALI command list; each of said ballast-side wireless modules automatically dispatches DALI commands from said additional DALI command list to said DALI compatible controlled device during the period when said DALI controller is dormant; said DALI commands being dispatched in a manner reflective of the DALI command's priority; data in said data store being maintained current; and each ballast-side wireless module transmitting data in the data store to the controller-side wireless module when there is a change to the data or when a preprogrammed time elapse has transpired.

4. The wireless lighting control system of claim 1 wherein the controller-side wireless module comprises a controller DALI driver, a data encapsulator, a cache manager, and a data store; and wherein each ballast-side wireless module comprises a ballast DALI driver, a data sequencer, a cache engine, and a command list.

5. The wireless lighting control system of claim 4 wherein each ballast-side wireless module further comprises a DALI power supply.

6. A method for the encapsulation of DALI commands to operate a wireless lighting control system comprising the steps of:
providing a command list populated with DALI commands;
providing a status list populated with values;
providing a data store;
said data store storing data;
said data comprising commands received from a DALI controller;
said data further comprising back frames received from a DALI compatible controlled device;
creating a message packet;
said message packet comprising a command generated by a DALI controller, a timestamp for identifying when the command was generated, and a sequence ID for uniquely identifying said command.

7. The method for the encapsulation of DALI commands to operate a wireless lighting control system of claim 6 wherein:
the command list populated with DALI commands is provided on a ballast-side wireless module;
the status list populated with values is provided on the ballast-side wireless module;
the data store is provided on a controller-side wireless module;
and said data comprising back frames received from a DALI compatible control device are received from a ballast-side wireless module.

8. The method of claim 7 further comprising the steps of:
transmitting the message packet to the ballast-side wireless module,
sorting the message packet into the correct sequence,
comparing the command of the message packet with the command list,
and transmitting the command to a DALI compatible controlled device.

9. The method of claim 8 further comprising the steps of:
automatically transmitting a command from the command list to the DALI compatible controlled device,
receiving a back frame from the DALI compatible controlled device,
comparing the back frame to the value,
transmitting the back frame to the controller-side wireless module,
placing the back frame in the data store,
receiving a command from a DALI controller,
and transmitting the back frame to the DALI controller when appropriate under DALI protocol.

10. A lighting control system which conforms to wired system protocols and which incorporates a wireless communication system, said lighting control system comprising:
a lighting controller;
a first wire bus;
a controller-side wireless module;
at least one ballast-side wireless module;
at least one second wire bus;
at least one compatible controlled device;
and at least one lamp bank.

11. A building control system which conforms to wired system control protocols and which incorporates a wireless communication system, said building control system comprising:
a wired protocol controller;
a first wire bus;
a controller-side wireless module;
at least one ballast-side wireless module;
at least one second wire bus;
at least one controlled device;
and at least one lamp bank.

12. A method for the encapsulation of wired protocol commands to operate a building control system comprising the steps of:
providing a command list populated with commands on a ballast-side wireless module;
providing a status list populated with values on the ballast-side wireless module;
providing a data store on a controller-side wireless module;
said data store storing data;
said data comprising commands received from a lighting controller;
said data further comprising back frames received from a ballast-side wireless module;
creating a message packet;
said message packet comprising a command generated by a wired protocol controller, a timestamp for identifying when the command was generated, and a sequence ID for uniquely identifying said command.

13. The method of claim 12 further comprising the steps of:
transmitting the message packet to the ballast-side wireless module,
sorting the message packet into the correct sequence,
comparing the command of the message packet with the command list,
and transmitting the command to a wired protocol compatible controlled device.

14. The method of claim 13 further comprising the steps of:
automatically transmitting a command from the command list to the wired protocol compatible controlled device,
receiving a back frame from the wired protocol compatible controlled device,
comparing the back frame to the value,
transmitting the back frame to the controller-side wireless module,
placing the back frame in the data store,
receiving a command from a wired protocol compatible controller,
and transmitting the back frame to the wired protocol compatible controller when appropriate.
